(19) United States
(12) Patent Application Publication
(10) Pub. No.: US 2014/0250711 A1
(43) Pub. Date: Sep. 11, 2014

(54) ELECTRICAL MACHINE FOR EXTRACTING LIQUIDS

(71) Applicant: SAMMIC, S.L., Azkoitia (ES)

(72) Inventors: GORKA AGIRREZABAL OTEIZA, AZKOITIA (ES); AITOR GOGORZA SEGUROLA, AZPEITIA (ES)

(73) Assignee: SAMMIC, S.L., Azkoitia (ES)

(21) Appl. No.: 14/200,869

(22) Filed: Mar. 7, 2014

(30) Foreign Application Priority Data
Mar. 7, 2013 (ES) 201300207

(51) Int. Cl. A47J 43/04

(52) U.S. Cl. CPC A47J 43/04
USPC 34/108

(57) ABSTRACT

The present invention is an electric liquid extractor machine of the type that includes a basket for holding the product and that is designed to carry out operations such as centrifuging, draining or extracting of liquids, or other processing operations of habitual products in industrial kitchens or other types, structured on the basis of a rigid assembly including at least one body and an interior base, a movable assembly including at least one motor element, a drive shaft and a perforated basket, and a movable cover for the passage of products to the interior of the machine, characterised in that the union between the rigid assembly and the movable assembly is done by means of anti-vibration or flexible anchors.

The present invention refers to an electric liquid extractor machine for application in the industrial sector dedicated to the manufacturing and/or installation of food processing machines, in particular greens and the like, as well as the food, hotel and restaurant industry. The machine of the invention enables conducting different operations such as centrifuging, draining or extracting liquids, for example, water, oils, sauces or other food processing operations, and in particular of greens; operations that are normal in any type of kitchen, both industrial and domestic.

More precisely, the electric liquid extractor machine of the invention is one of the types that includes a basked for inserting the product, and is especially envisioned for working at different spinning speeds, depending on the needs of each type of product.

In the current state of the art there are many distinct apparatuses and machines that carry out operations related to centrifuging, draining or extracting liquids from greens, vegetables and other foods, hereinafter collectively the “products”. In general these machines are known to consist basically in a body in the interior of which there are two areas separated by an interior base, one of them being where the motor means are housed, for example, an electric motor, and a drive shaft that emerges vertically through the internal base and which has a perforated basket attached to it where the products are placed. When this known machine is started up, the perforated basket begins to rotate and, due to the centrifugal force, the liquid present in the products is moved towards the exterior of the perforated basket through its orifices, falling down towards the interior base and being channelled towards the exterior of the machine.

One of the most important problems of these known machines is that normally the manual placement of the products in the perforated basket can provoke a shift in the centre of gravity of the perforated basket—products assembly with respect of the drive shaft, which provokes vibrating problems in the machine. To limit these vibrations, the conventional option is to reduce the rotation speed and/or fix the machine to the ground, which first of all entails the subsequent limitation of the rotation speed and the impossibility of adapting said speeds to the type of products, and second of all it results in extremely limited functionality when handling the machine as a result of the machine being fixed in place with fixing systems, such as in the event the need arises to move it to another place, for example.

Thus, in light of the machines in the current state of the art, an objective of the present invention is to substantially improve the operating and functional possibilities offered by these known machines and, to do so, to provide a machine designed for applying a range of differing speeds depending on and adapting itself to the products and the external conditions, while at the same time reducing the vibrating and shaking of the machine. Therefore, a subject of the present invention is a machine for extracting liquids from the products with variable rotation speed and vibration absorption. The machine of the present invention enables an optimal draining of the products and of the amount of product introduced by means of selecting a suitable work program by incorporating means and devices especially designed in order to: 1) obtain that the operations of introduction and extraction of the perforated basket can be carried out quickly and easily; 2) the load distribution of the perforated basket can be detected and the operating parameters adjusted automatically; 3) the reduction of the vibrating and shaking of the machine, even at operating speeds that are higher than those employed up until now by the models currently in the market, and 4) the guarantee of greater safety for the operator, based on a machine that immediately and automatically stops when the dynamic cycle parameters exceed some preset safety values.

In order to do so, the structure of the machine of the invention is based on a rigid assembly comprising at least a body and a bottom base, and a moveable assembly, joined to the rigid assembly by means of anti-vibration or flexible anchors, and comprised of at least one motor element, a drive shaft and a perforated basket coupled to said drive shaft; the machine being equipped on its top portion with a moveable cover through which the products can be introduced and extracted.

The moveable assembly is joined to the rigid assembly by means of said anti-vibration or flexible anchors located between the bottom base and the motor element, which enables the moveable assembly to have a certain degree of vertical, horizontal or rotational shift with respect of the rigid assembly, as well as of the rotational spin of the machine itself, which favours its improved operating.

The fact that the moveable assembly can vertically, horizontally or rotationally shift (independently of the real rotational spin of the machine) with respect to the rigid assembly makes it necessary for there to be a gap between both assemblies, or that the union be made with an element that allows said movements. Due to the purpose of the machine, namely to eliminate as much as possible the liquids present in the products, it is designed in such a way that said liquids can be channelled in order to avoid the possibility of damaging the components of the machine. In this context, the gap between the rigid assembly and the moveable assembly could cause a loss of waterproofing which would affect components such as the motor element. In order to avoid said problem, the interior base is equipped with a neck and the drive shaft incorporates an umbrella that covers said neck of the interior base; being likewise equipped with a cover having a lid with a latch over the motor element which completely protects it.

Said interior base has some curved surfaces that help collect the liquids and direct them towards an output orifice for the purpose of being evacuated.

For its part, the perforated basket incorporates in the centre of its bottom base an essentially conical guide and a geometrically notched crown, being projected vertically downwards and having chamfered surfaces. The conical guide of the basket facilitates its placement onto the drive shaft, while at the same time some radial pins arranged on the drive shaft are inserted into the geometrically notched crown, which have the function of transmitting the drive shaft rotation to the perforated basket.

In certain cases during the mounting of the perforated basket, the notches of the basket remain above the drive shaft pins. To avoid this, each time the machine is started up, the drive shaft rotates a few times and brusquely stops, which causes the basket to rotate and shift downwards due to this manoeuvre and the notched geometry of the basket having chamfered surfaces, and the drive shaft pins to be introduced into the channels of the notches of the crown of the perforated basket. This facilitates a quick placement of the perforated basket. To remove the basket from the machine, it suffices to carry out an ascending vertical movement above the machine. In other words, the perforated basket is easily removable.

Furthermore, the machine is also equipped with a control and regulation unit for measuring the off centering of the load, which enables its operation under different circumstances, for example, by means of including vibration sensors, typically accelerometers. The information provided by these accelerometers is transmitted to the control and regulation unit of the machine, which determines the parameters of the work cycle or can even can stop it if the vibration is excessive, alerting the user to distribute the products better.

The machine is likewise equipped with diverse security devices for guaranteeing the user a very safe operability. For example, the machine can detect whether the cover is open or closed by means of position or presence sensors, in such a way that the machine can only be started up when the cover is in the closed position. Moreover, if during the work cycle the vibration measuring devices detect that the vibrations are exceeding certain limits considered to be safe for correct maintenance of the mechanical components of the machine, an emergency brake system is automatically activated, which is able to completely stop the machine in a few seconds. This emergency brake system is also activated if for any reason the cover opens while the machine is operating.

The following is a description of the invention based on a manner of embodiment of the same and with reference to the attached figures, as follows:

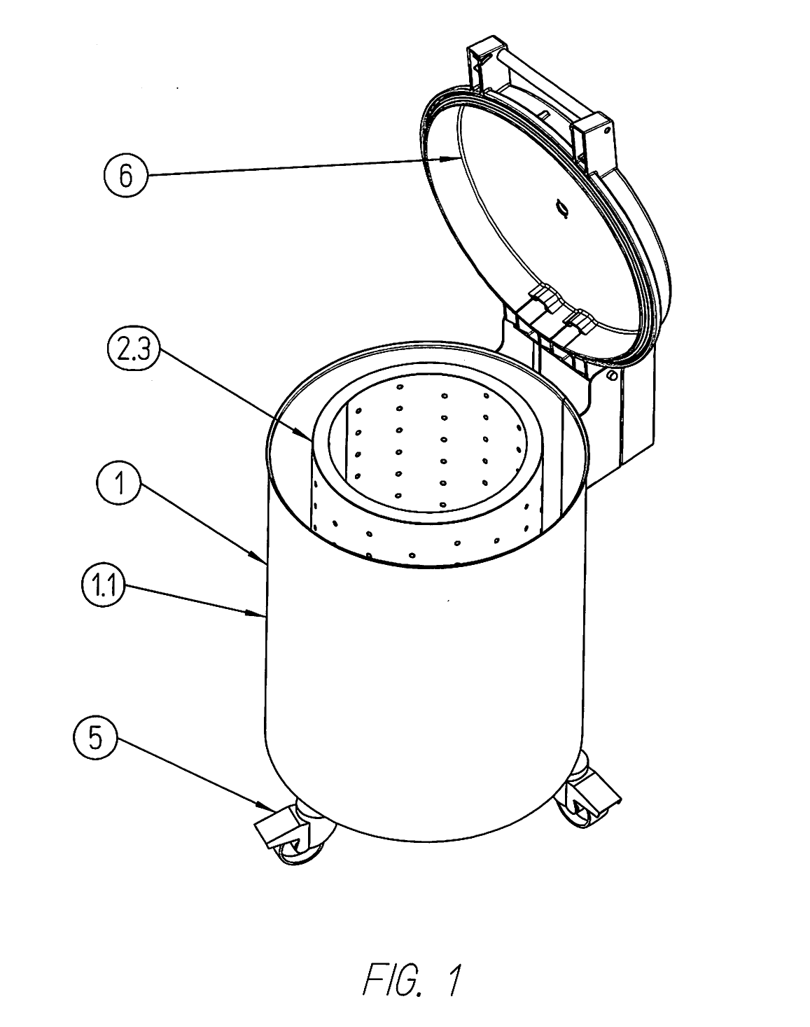

FIG. 1: An isometric representation of the machine of the invention in accordance with an embodiment of the same.

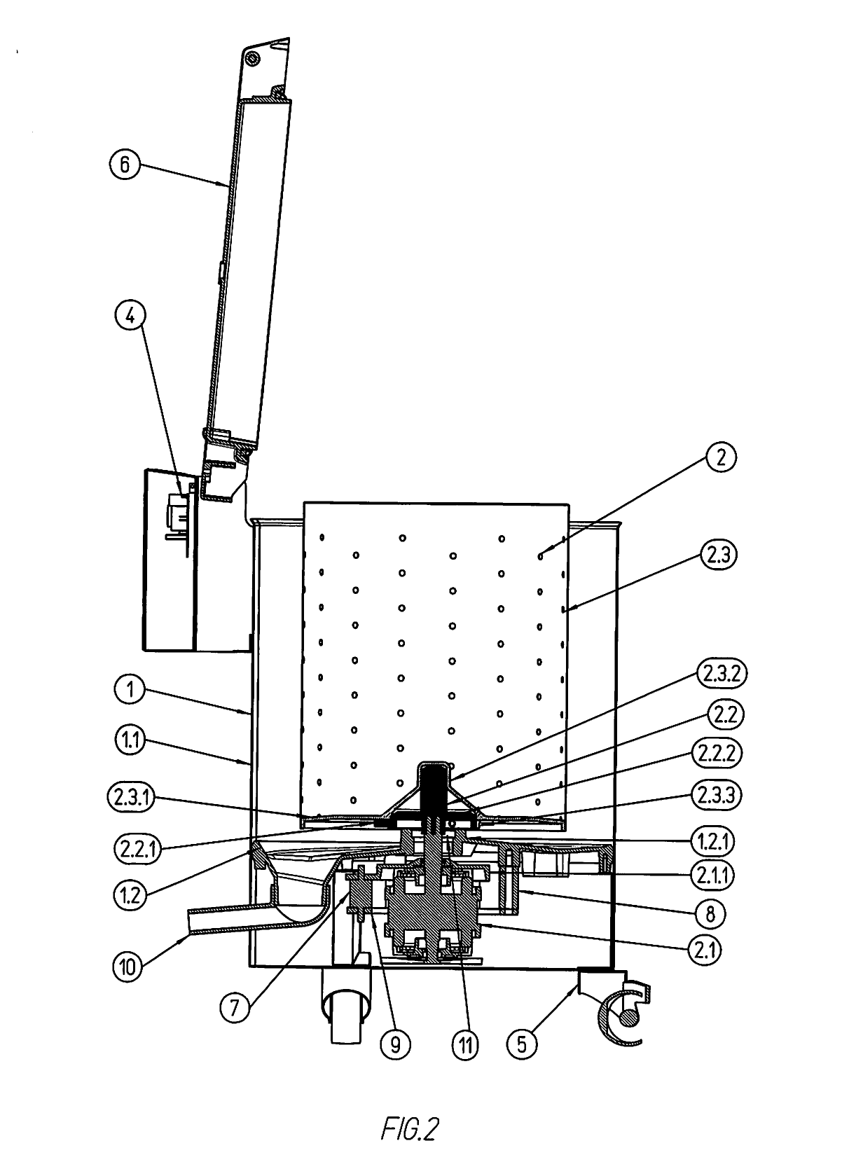

FIG. 2: A transversal cross section view of the machine of FIG. 1.

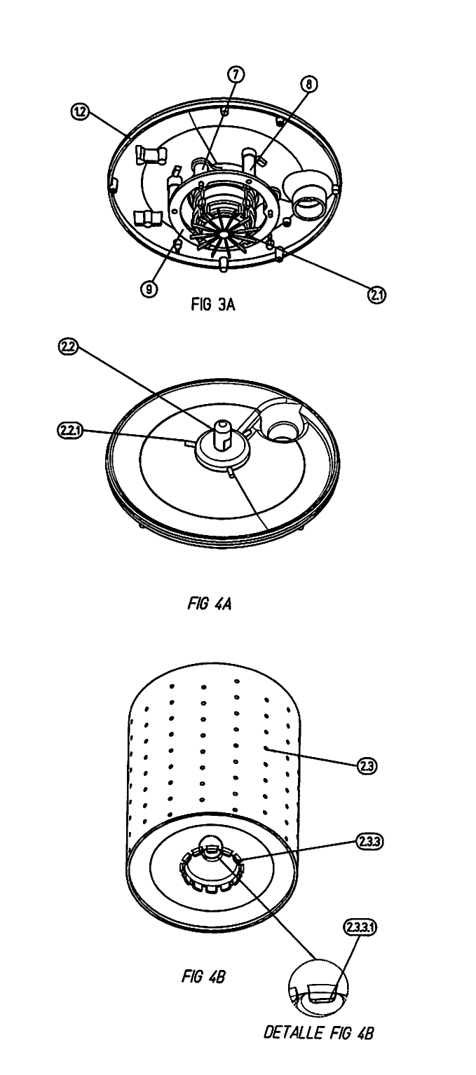

FIG. 3A: A view of the mounting system of the motor element with the interior base by means of anti-vibration or flexible anchors on to the machine of FIG. 1.

FIG. 4A: A view of the union between the perforated basket and the drive shaft in accordance with FIG. 1.

FIG. 4B: A view of the union between the perforated basket and the drive shaft in accordance with FIG. 1.

In the present description, terms such as vertical, horizontal, top or bottom, above or below, or others having an equivalent nature are expressed in accordance with the normal operating position of the machine. In the figures the reference numbers designate equal or equivalent parts.

In the first place and with reference to FIG. 1, an isometric representation is displayed of a machine in accordance with the invention, being visible a rigid assembly (1), which is a body (1.1) having a rigid nature, which in this embodiment is supported on some wheels (5), although it can be supported on legs or a base. Body (1.1) incorporates a moveable cover (6) through which the products can be introduced into perforated basket (2.3) deployed inside body (1.1). In the non-limiting embodiment displayed, the moveable cover (6) is joined to body (1.1) by means of a hinge.

FIG. 2 displays a transverse cross section of the machine of FIG. 1, in which rigid assembly (1) can be seen, comprised by body (1.1) and interior base (1.2), and moveable assembly (2) comprised by motor element (2.1), drive shaft (2.2) and perforated basket (2.3).

Rigid assembly (1) is joined to moveable assembly (2) by means of anti-vibration or flexible anchors (7); in this embodiment it is joined to motor element (2.1). As can be seen in FIG. 2, interior base (1.2) has some cylinders (8) coupled to it which hold support ring (9). Anti-vibration or flexible anchors (7), with which motor element (2.1) is fixed, are fixed to support ring (9). FIG. 3A displays this assembly in an isometric manner. In this embodiment anti-vibration or flexible anchors (7) remain in the compressed state. Obviously the mounting of anti-vibration or flexible anchors (7) can be done in different ways, arranged in such a way that they remain in tension or compression. For example, to leave it in tension, it would be sufficient to fix motor element (2.1) directly to internal base (1.2) by means of anti-vibration or flexible anchors (7). Likewise, the union between the rigid assembly and the moveable assembly can be done in different manners, for example joining motor element (2.1) to a base placed at the bottom portion of the machine (not represented in the figures).

The union between rigid assembly (1) and moveable assembly (2) through the anti-vibration or flexible anchors (7) enables moveable assembly (2) a certain degree of vertical, horizontal or rotational shift (independently of the real rotational spin of the machines) with respect of rigid assembly (1), causing an gyroscopic effect to appear and reducing the vibrations that are created by centrifugal forces in the machine. The machine furthermore is equipped with control and regulating unit (4) that receives information from the vibration measuring devices (not shown) for calculating the correct operating speed.

In the event the vibrations exceed some limits considered as safe for the correct maintenance of the mechanical elements of the machines, control unit (4) automatically activates an emergency brake system capable of completely stopping the machine in a few seconds.

As can be seen in FIGS. 2, 4A and 4B, perforated basket (2.3) is removable and has in its interior a base (2.3.1) in the centre of which there is a conical guide (2.3.2) and a geometrically notched crown (2.3.3) having chamfered surfaces (2.3.3.1). On the one part, conical guide (2.3.2) helps and positions perforated basket (2.3) on drive shaft (2.2), and on the other part, some radial pins (2.2.1) present on drive shaft (2.2) are introduced into geometrically notched crown (2.3.3), which transmits the rotation of drive shaft (2.2) to perforated basket (2.3).

When mounting perforated basket (2.3), in order to avoid that the notches of crown (2.3.3) of perforated basket (2.3) are left above pins (2.2.1) of drive shaft (2.2), every time the machine starts up drive shaft (2.2) rotates a few times and brusquely stops, which, on account of this manoeuvre and the geometry of the notches of crown (2.3.3.) of perforated basket (2.3), causes the basket to rotate and shift downwards, leaving the drive shaft pins in the channels of the notches of the crown of the perforated basket.

Just as has been stated above, moveable assembly (2) can be shifted vertically, horizontally or by spinning (independently of the real rotational spin of the machines) with respect of rigid assembly (1), for which the liquid channelling system is designed to correspond to this circumstance.

In the machines of the known art, the liquid extracted from the products falls into internal base (1.2) and from there it is channelled by means of a tube outside the machine.

Bearing in mind that the earlier machines did not permit the spinning (independently of the rotational spin) or the shift of drive shaft (2.2) with respect of internal base (1.2), retaining elements are deployed between drive shaft (2.2) and internal base (1.2).

In this embodiment of the machine of the invention, given that it has incorporated the ability of shifting vertically, horizontally or by spinning (independently of the real rotational spin of the machines) moveable assembly (2), it is installed with gap (11), or an element is incorporated (not represented) that enables these movements of drive shaft (2.2), which reduces the waterproofing of the machine. To prevent this loss of waterproofing, neck (1.2.1) is installed on internal base (1.2) and an umbrella (2.2.2) to drive shaft (2.2), as well as a lid with latch (2.1.1) for protecting motor element (2.1) which it completely covers.

As has been stated, optionally there is a union between the moveable assembly and the rigid assembly that may be installed in such a way that the anti-vibration or flexible anchors are left in the tension or compression state when the machine is stopped. Likewise the union of the moveable assembly can be to the interior base or other rigid elements of the machine. Under these conditions and by increasing the rotation speed, the desired gyroscopic effect is created and the parasitical moments associated to the off centring of the load on the drive shaft tend to be minimised.

1-10. (canceled)

11. A liquid extractor machine comprised of:
a movable assembly comprised of a motor, a drive shaft, and a perforated basket;
a rigid assembly comprised of a body and an interior base;
a cover;
wherein the rigid assembly and movable assembly are connected by anti-vibration anchors;
the interior base divides the interior body into two areas;
the motor and perforated basket are located in the interior of the body, on opposite sides of the interior base, and are connected by the drive shaft which passes through an opening in the interior base.

12. The liquid extractor machine of claim 11 wherein the opening in the interior base is sized to create a gap between the interior base and the drive shaft which passes through it.

13. The liquid extractor machine of claim 12 wherein the gap between the interior base and the drive shaft is spanned by a flexible, waterproof material.

14. The liquid extractor machine of claim 12 wherein the interior base of the rigid assembly includes a neck which protrudes from the surface thereof.

15. The electric liquid extractor machine of claim 14 wherein the drive shaft of the movable assembly includes an umbrella that covers the neck of the interior base.

16. The electric liquid extractor machine of claim 12 wherein the perforated basket includes a conical guide on its base as well a series of notches arranged in a circular formation and the drive shaft includes radial pins which are sized and positioned to be accepted by the notches of the perforated basket.

17. The electric liquid extractor machine of claim 12 including a control and regulation unit and accelerometers.

18. The electric liquid extractor machine of claim 17 wherein the control and regulation unit receives measurements from the accelerometer and based upon those measurements adjusts the operating speed of the motor.

19. The electric liquid extractor machine of claim 12 wherein the body is composed of a rigid material and is supported on a set of wheels.

20. The electric liquid extractor machine of claim 12 wherein the perforated basket is dismountable from the drive shaft.

21. The electric liquid extractor machine of claim 12 wherein the motor has a cover which is comprised of a lid and a latch.
